(19) United States
(12) Patent Application Publication
(10) Pub. No.: US 2021/0024121 A1
(43) Pub. Date: Jan. 28, 2021

(54) STEERING COLUMN DEVICE

(71) Applicant: FUJI KIKO CO., LTD., Kosai-shi (JP)

(72) Inventor: Mitsuyoshi MATSUNO, Kosai-shi (JP)

(21) Appl. No.: 16/933,246

(22) Filed: Jul. 20, 2020

(30) Foreign Application Priority Data
Jul. 25, 2019 (JP) 2019-136955

(51) Int. Cl. B62D 1/19; B62D 1/185

(52) U.S. Cl. CPC B62D 1/197; B62D 1/185

(57) ABSTRACT

A steering column device includes a lower jacket to be mounted on a vehicle body, an upper jacket provided to be movable in front and rear directions of the vehicle body with respect to the lower jacket, an electric actuator provided on the lower jacket for moving the upper jacket in the front and rear directions of the vehicle body, a drive member transmitting a drive force of the electric actuator to the upper jacket, an energy absorption mechanism arranged between the upper jacket and the drive member, and a switching mechanism arranged between the drive member and the energy absorption mechanism, the switching mechanism switching between a state in which the energy absorption mechanism is locked with respect to the drive member and a state in which locking of the energy absorption mechanism with respect to the drive member is released.

### CROSS REFERENCE TO RELATED APPLICATIONS

The present application is based on, and claims priority from Japanese Patent Application No. 2019-136955, filed Jul. 25, 2019, the disclosure of which is hereby incorporated by reference herein in its entirety.

### BACKGROUND

### 1. Technical Field

The present invention relates to a steering column device.

### 2. Description of the Related Art

A steering column device according to Japanese Patent Application Publication No. 2007-76647 includes a vehicle body mounting bracket with a pair of side walls, which is fixed to a vehicle body, and a steering column arranged between the pair of side walls in a longitudinal direction of the vehicle body. The pair of side walls of the vehicle body mounting bracket supports the steering column movable in tilt directions and telescopic directions. The steering column is configured to include an upper jacket supporting a steering wheel, and a lower jacket provided to cover the outer circumference of the upper jacket. Moreover, an energy absorption mechanism and the like are provided between the vehicle body mounting bracket and the steering column.

### SUMMARY

In the above steering column device, the entire steering column moves with respect to the vehicle body in a secondary collision, and thus a space needs to be left on the vehicle body side for the steering column to move in the secondary collision.

Accordingly, an object of the present invention is to save space in a steering column device by eliminating the need for the space for a steering column to move in a secondary collision.

A steering column device according to an aspect of the present invention includes a lower jacket to be mounted on a vehicle body, an upper jacket provided to be movable in front and rear directions of the vehicle body with respect to the lower jacket, an electric actuator provided on the lower jacket for moving the upper jacket in the front and rear directions of the vehicle body, a drive member transmitting a drive force of the electric actuator to the upper jacket, an energy absorption mechanism arranged between the upper jacket and the drive member, and a switching mechanism arranged between the drive member and the energy absorption mechanism, the switching mechanism switching between a state in which the energy absorption mechanism is locked with respect to the drive member and a state in which locking of the energy absorption mechanism with respect to the drive member is released.

The steering column device according to an aspect of the present invention eliminates the need for the space for the steering column to move in a secondary collision and achieves space saving in the steering column device.

### BRIEF DESCRIPTION OF THE DRAWINGS

FIG. 1 is a perspective view of a steering column device according to an embodiment of the present invention as seen from the bottom of a vehicle body.

FIG. 2 is an exploded perspective view of the steering column device according to the embodiment of the present invention as seen from the bottom of the vehicle body.

FIG. 3 is a plan view of the steering column device according to the embodiment of the present invention as seen from the bottom of the vehicle body.

FIG. 4 is a schematic enlarged plan view of a main part of the steering column device according to the embodiment of the present invention as seen from the bottom of the vehicle body.

FIG. 5 is a schematic enlarged side sectional view of the main part of the steering column device according to the embodiment of the present invention with a high load setting in a secondary collision.

FIG. 6 is a schematic enlarged side sectional view of the main part of the steering column device according to the embodiment of the present invention with the high load setting after the secondary collision.

FIG. 7 is a schematic enlarged side sectional view of the main part of the steering column device according to the embodiment of the present invention with a low load setting in a secondary collision.

FIG. 8 is a schematic enlarged side sectional view of the main part of the steering column device according to the embodiment of the present invention with the low load setting after the secondary collision.

FIG. 9 is a schematic enlarged plan view of a main part of a steering column device according to another embodiment of the present invention as seen from the bottom of a vehicle body.

FIG. 10 is a schematic enlarged side sectional view of the main part of the steering column device according to the other embodiment of the present invention with a high load setting in a secondary collision.

FIG. 11 is a schematic enlarged side sectional view of the main part of the steering column device according to the other embodiment of the present invention with the high load setting after the secondary collision.

FIG. 12 is a schematic enlarged side sectional view of the main part of the steering column device according to the other embodiment of the present invention with a low load setting in a secondary collision.

FIG. 13 is a schematic enlarged side sectional view of the main part of the steering column device according to the other embodiment of the present invention with the low load setting after the secondary collision.

### DESCRIPTION OF EMBODIMENTS

Embodiments according to the present invention are described below with reference to figures.

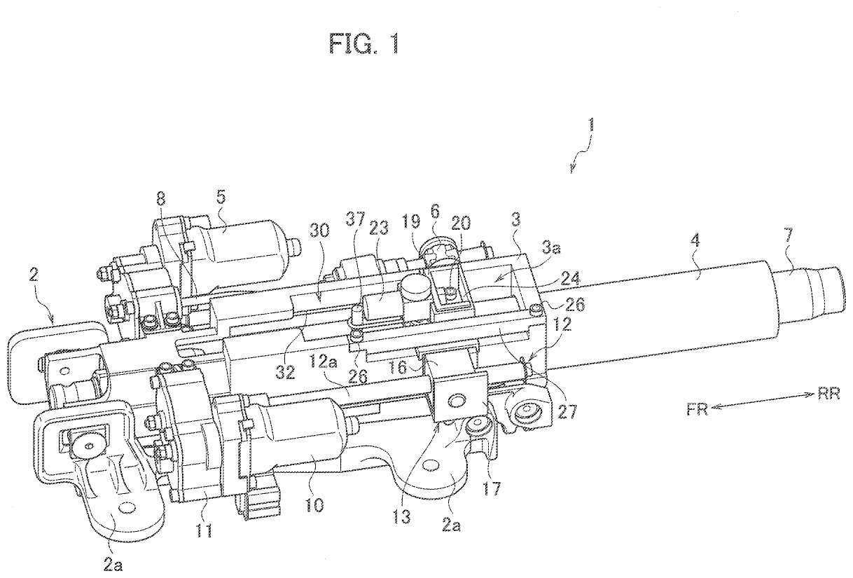

FIGS. 1 to 3 illustrate a steering column device 1 according to an embodiment of the present invention. Note that for the steering column device 1 mounted on a vehicle body, a direction indicated by an arrow FR in FIG. 1 is the front of the vehicle body, and a direction indicated by an arrow RR in FIG. 1 is the rear of the vehicle body. In the following, “front” indicates the front of the vehicle body, “rear” indicates the rear of the vehicle body, and “left and right directions” indicate left and right directions as seen from the rear to the front of the vehicle body.

The steering column device 1 includes a vehicle body mounting bracket 2 to be mounted on the vehicle body not-shown, a lower jacket 3 supported to be swingable in up and down directions with respect to the vehicle body mounting bracket 2, and an upper jacket 4 movable in front and rear directions of the vehicle body with respect to the lower jacket 3. The vehicle body mounting bracket 2 includes a mounting part 2a at multiple locations and is mounted on the vehicle body through the mounting part 2a.

The lower jacket 3 swings in the up and down directions with respect to the vehicle body mounting bracket 2 through a tilt drive motor 5, and a screw mechanism 6, a flexible shaft 8 and the like driven by the tilt drive motor 5. The tilt drive motor 5, the screw mechanism 6, the flexible shaft 8, and the like are provided on the left side of the steering column device 1. Note that depending on mounting positions or shapes of the tilt drive motor 5 and the screw mechanism 6, the screw mechanism 6 may be directly connected to the side of the tilt drive motor 5 without the flexible shaft 8.

When the lower jacket 3 swings in the up and down directions, the upper jacket 4, and a steering shaft 7 rotatably inserted in the upper jacket 4 swing together. A not-shown steering wheel is attached to a rear end part of the steering shaft 7.

Accordingly, the steering column device 1 includes an electric tilt mechanism that makes the steering wheel swingable in the up and down directions (tilt directions). The steering column device 1 further includes an electric telescopic mechanism that makes the steering wheel movable in the front and rear directions (telescopic directions). The electric telescopic mechanism is described below.

The electric telescopic mechanism includes a telescopic drive motor 10 (hereinafter simply referred to as “motor”) as an electric actuator attached to the right side of the lower jacket 3. The motor 10 is attached to the lower jacket 3 together with a reduction mechanism part 11. A screw shaft (screw bolt) 12 driven to rotate by the motor 10 extends in an axial direction of the upper jacket 4 having a cylindrical shape.

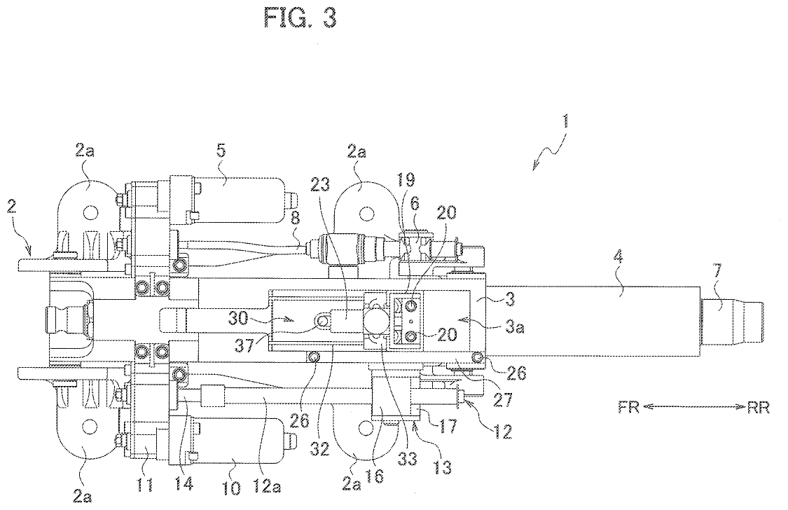

The screw shaft 12 includes a male screw part 12a to which a dnve member 13 is screwed, and a shaft part 14 located in front of the male screw part 12a (see FIG. 3). The screw shaft 12 is connected to the reduction mechanism part 11 through the shaft part 14. The shaft part 14 of the screw shaft 12 is rotatable with respect to the lower jacket 3 with axial movement restricted with respect to the lower jacket 3. Note that depending on mounting positions or shapes of the motor 10 and the reduction mechanism part 11, a shaft part of the screw shaft 12 may be directly connected to the reduction mechanism part 11 using a flexible shaft.

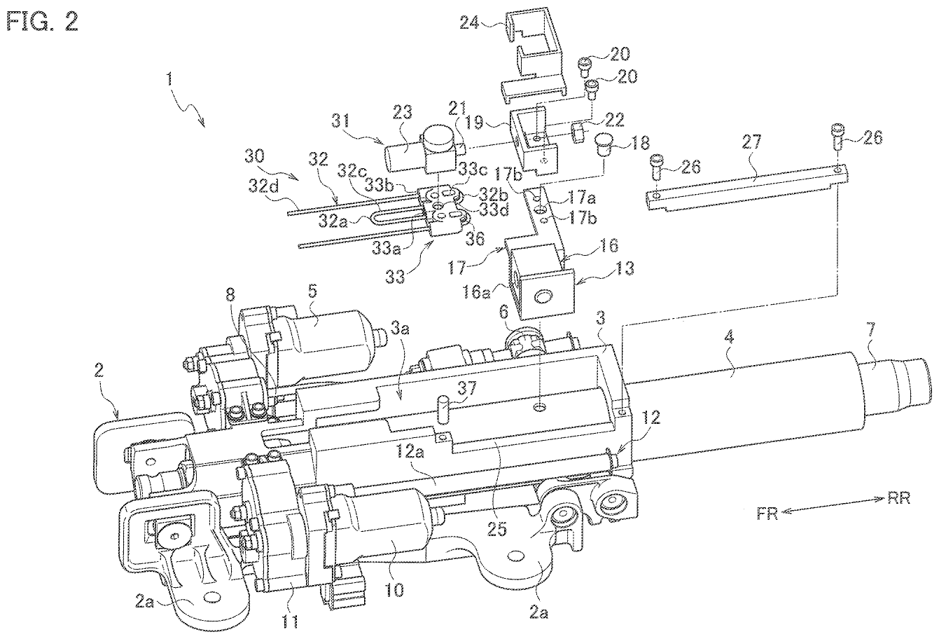

The drive member 13 includes a nut part (screw nut) 16 to be screwed to the male screw part 12a, and a body part 17 formed to extend from the nut part 16 on a side of the upper jacket 4. The nut part 16 is in a square tube shape and has a female screw 16a formed on the inner surface of the square tube. The body part 17 has a shear pin insertion hole 17a, to which a shear pin (connecting pin) 18 is inserted, and bolt fixing holes 17b, to which fixing bolts 20 for a fixing bracket 19 are screwed, formed on an end part of the body part 17 on a side of the upper jacket 4. The fixing bracket 19 is fixed using the fixing bolts 20 on the end part of the body part 17 on the side of the upper jacket 4, and a pyro actuator 23 that will be described later is mounted on the fixing bracket 19 using a stud bolt 21 and a mounting nut 22 (see FIG. 2). Moreover, a stiffening part 24 for mainly stiffening the body part 17 is attached to the end part of the body part 17 on the side of the upper jacket 4. The drive member 13 is movable along a guide recess part 25 (see FIG. 2) formed on the lower jacket 3 in an axial direction, and an opening side of the guide recess part 25 is closed by a closing member 27 fixed to the lower jacket 3 using closing bolts 26.

In the steering column device 1, an energy absorption mechanism 30 for absorbing energy in a secondary collision is arranged between the upper jacket 4 and the drive member 13, and a switching mechanism 31 is arranged between the drive member 13 and the energy absorption mechanism 30.

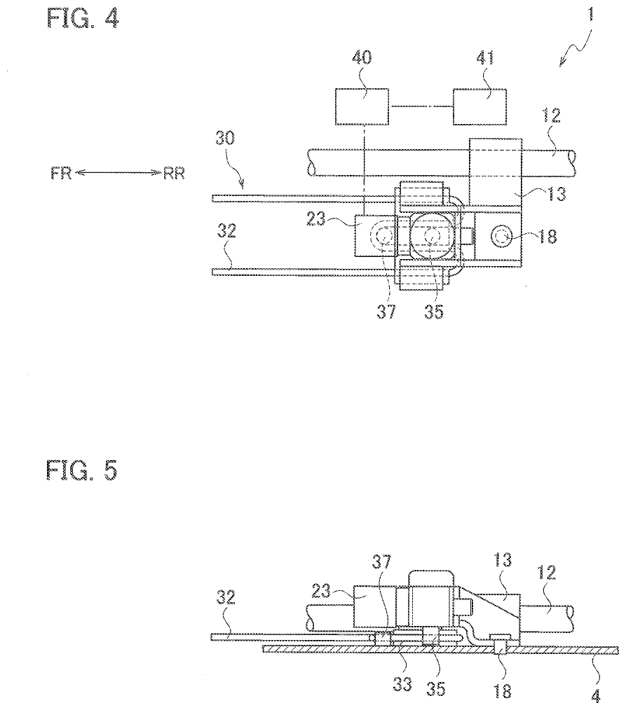

The energy absorption mechanism 30 shown in FIG. 4 is also called as an EA (Energy Absorption) load generation unit and includes a wire (rubbed wire) 32 and a wire holder 33 holding the wire 32.

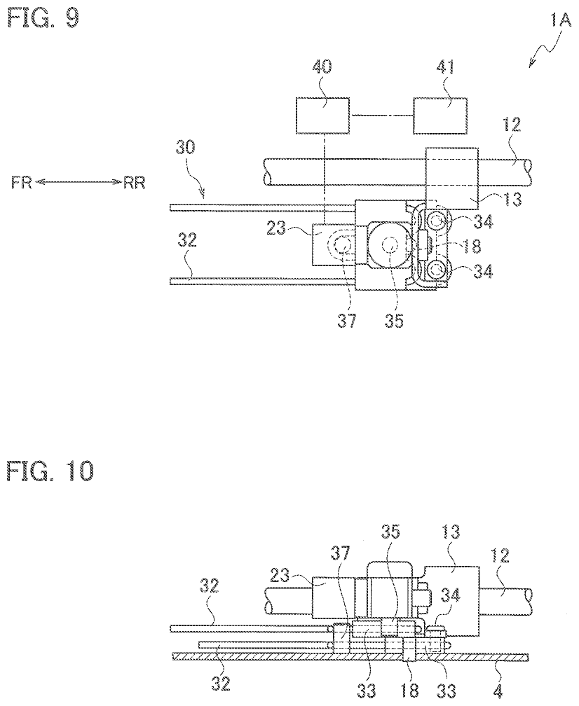

The wire holder 33 is made of a resin in a rectangular shape in a plan view and includes a pair of mounting holes 33c penetrating in a thickness direction for set screws 34 (used in another embodiment shown in FIG. 9), and a locking hole 33d penetrating in a thickness direction for a locking pin 35 (see FIG. 4, etc.). The wire holder 33 includes three large and small wire insertion holes 33a, 33b formed to penetrate in a short side direction, and guide protrusion parts 36 in a semi-cylindrical shape formed to protrude on an end part on an open side of the wire insertion holes 33a, 33b between the wire insertion holes 33a, 33b. The mounting holes 33c and the locking hole 33d are provided between the adjacent wire insertion holes 33a, 33b. The wire insertion hole 33a with a large hole diameter is formed to have an oval cross section (may have a rectangular cross section), and the wire insertion holes 33b with a small hole diameter are formed to have a size for the wire 32 with a circular cross section to be inserted. The outer surfaces of the guide protrusion parts 36 in a semi-cylindrical shape are arc-shaped guide surfaces for the wire 32.

The wire 32 is bent and formed in a W shape or an M shape in a plan view by bending a single metal wire having a circular cross section at a bent base part 32a and at two bent arc parts 32b with predetermined curvatures. The wire 32 includes a twin wire part 32c bent in a U shape at the bent base part 32a on the front side, and a pair of leg parts 32d formed by bending back the both free ends of the twin wire part 32c at the bent arc parts 32b in the opposite direction. Then, the twin wire part 32c on the side of the bent base part 32a on the front side is inserted to the wire insertion hole 33a, and the leg parts 32d on the both sides of the twin wire part 32c are inserted to the wire insertion holes 33b, respectively, so that the wire 32 is supported by the wire holder 33.

On that occasion, the curvatures of the two bent arc parts 32b on the rear side are respectively set to match those of the guide surfaces of the guide protrusion parts 36, so that the two bent arc parts 32b on the rear side are supported to be wound around the guide surfaces of the guide protrusion parts 36. In the assembled state shown in FIG. 1, the bent base part 32a of the wire 32 on the front side is locked to a locking protrusion part 37 formed on an outer periphery part of the upper jacket 4. Note that as understood from FIG. 2, the locking protrusion part 37 of the upper jacket 4 is received in a slit (receiving part) 3a of the lower jacket 3.

Accordingly, the energy absorption mechanism 30 is formed by the wire holder 33 as a holding member, the wire 32 supported by the wire holder 33, and the locking protrusion part 37 of the upper jacket 4 to which the bent base part 32a of the wire 32 on the front side is locked.

The switching mechanism 31 switches between a state in which the energy absorption mechanism 30 is locked and held with respect to the drive member 13 and a state in which the locking and holding of the energy absorption mechanism 30 with respect to the drive member 13 is released.

The switching mechanism 31 includes a locking pin 35 that locks the energy absorption mechanism 30, and the pyro actuator 23 that actuates the locking pin 35. The locking pin 35 is inserted to the locking hole 33d formed on the wire holder 33 of the energy absorption mechanism 30.

The pyro actuator 23 is fixed to the fixing bracket 19 of the drive member 13. The pyro actuator 23 is configured to have the locking pin 35 normally inserted in the locking hole 33d and to have the locking pin 35 pulled out from the locking hole 33d by explosion of gunpowder. Note that contrary to the present embodiment, it may be configured to have the locking pin 35 normally being out of the locking hole 33d and to have the locking pin 35 inserted to the locking hole 33d by the pyro actuator 23 in response to a collision signal (actuation signal) in a secondary collision.

Ignition on and ignition off of the pyro actuator 23 is controlled by an electronic control unit (ECU) 40 (see FIG. 4). The electronic control unit 40 receives outputs from driving state detecting sensors, such as a seat position sensor, a driver weight sensor, a vehicle speed sensor, an occupant position sensor and a seat belt wearing sensor, and from an impact detection sensor that detects the impact on the steering wheel. The electronic control unit 40 determines whether there is a collision in accordance with output information from sensors 41 (see FIG. 4) including these sensors and determines whether to set the energy absorption mechanism 30 to a low load setting or to a high load setting when determining that there is a collision. Then, when determining to set to the low load setting, the electronic control unit 40 outputs an actuation signal (that is, an ignition signal) to the pyro actuator 23, and when determining to set to the high load setting, the electronic control unit 40 does not output the actuation signal (that is, the ignition signal) to the pyro actuator 23.

Next, operation of the steering column device 1 in a secondary collision is described.

When it is determined to set the high load setting due to a relatively large impact load given to the steering wheel from a driver in a secondary collision, and the like, the pyro actuator 23 remains off as shown in FIG. 5. When the pyro actuator 23 remains off, the wire holder 33 of the energy absorption mechanism 30 is held by the locking pin 35 with respect to the drive member 13.

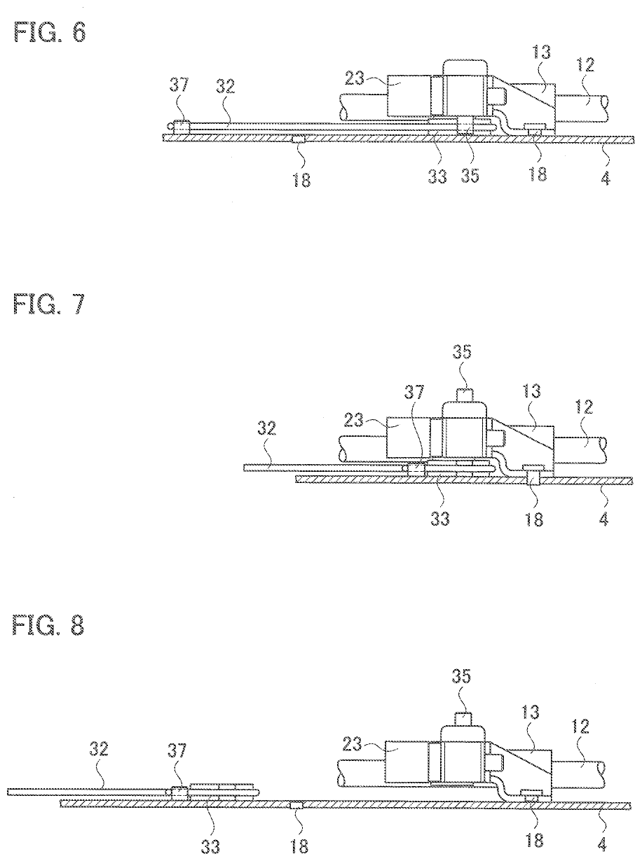

When an upper part of the steering shaft 7 and the upper jacket 4 move forward in the axial direction due to the impact load given to the steering wheel, the shear pin 18 receives a shearing force by the movement to be cut, so that the upper jacket 4 is detached from the drive member 13. The detached upper jacket 4 moves forward together with the upper part of the steering shaft 7. Then, as shown in FIG. 6, the wire 32 of the energy absorption mechanism 30 is pulled forward by the locking protrusion part 37 to be plastically deformed, and thus the energy in the secondary collision is absorbed by the plastic deformation. Moreover, when the upper jacket 4 moves forward in the axial direction, the energy in the secondary collision is absorbed also by slide resistance with respect to the lower jacket 3. As described above, the plastic deformation of the wire 32 and the slide resistance of the upper jacket 4 with respect to the lower jacket 3 effectively absorb a relatively large amount of energy.

On the other hand, when it is determined to set the low load setting due to a relatively small impact load given to the steering wheel from a driver in a secondary collision, and the like, the pyro actuator 23 is turned on, as shown in FIG. 7. When the pyro actuator 23 is turned on, the locking pin 35 is pulled off from the locking hole 33d of the wire holder 33, and the holding of the wire holder 33 of the energy absorption mechanism 30 with respect to the drive member 13 is released.

When the upper part of the steering shaft 7 and the upper jacket 4 move forward due to the impact load given to the steering wheel, the wire 32 of the energy absorption mechanism 30 is pulled forward by the locking protrusion part 37, and the wire holder 33 also moves forward together with the wire 32. As shown in FIG. 8, since the wire holder 33 also moves forward together with the wire 32, the energy absorption mechanism 30 does not contribute to the energy absorption in the secondary collision. When the upper jacket 4 moves forward, the energy in the secondary collision is absorbed by the slide resistance with respect to the lower jacket 3.

In summary, in the case of the low load setting, energy in the secondary collision is absorbed by only the slide resistance of the upper jacket 4 with respect to the lower jacket 3, so that a relatively small amount of energy is effectively absorbed. On the other hand, in the case of the high load setting, energy in the secondary collision is absorbed by both the plastic deformation of the wire 32 and the slide resistance of the upper jacket 4 with respect to the lower jacket 3, so that a relatively large amount of energy is effectively absorbed.

Operation and effects according to the present embodiment are described below.

(1) The steering column device 1 includes the lower jacket 3 to be mounted on a vehicle body, and the upper jacket 4 provided to be movable in front and rear directions of the vehicle body with respect to the lower jacket 3. Moreover, the steering column device 1 includes the electric actuator (motor 10) provided on the lower jacket 3 for moving the upper jacket 4 in the front and rear directions of the vehicle, and the drive member 13 transmitting a drive force of the motor 10 to the upper jacket 4. Furthermore, the steering column device 1 includes the energy absorption mechanism 30 arranged between the upper jacket 4 and the drive member 13. The steering column device 1 includes the switching mechanism 31 arranged between the drive member 13 and the energy absorption mechanism 30, the switching mechanism 31 switching between a state in which the energy absorption mechanism 30 is locked with respect to the drive member 13 and a state in which locking of the energy absorption mechanism 30 with respect to the drive member 13 is released.

According to the present embodiment, the space for the steering column to move to the vehicle side is eliminated, achieving space saving in the steering column device 1. Moreover, the EA load is changed in accordance with the presence or absence of an actuation signal from the sensors, improving collision safety performance of a vehicle on which the steering column device 1 is mounted.

(2) The switching mechanism 31 includes the locking pin 35 that locks the energy absorption mechanism 30, and the pyro actuator 23 that actuates the locking pin 35.

The switching mechanism 31 with such a configuration makes the EA load changed in accordance with the presence or absence of an actuation signal from the sensors, improving collision safety performance of a vehicle on which the steering column device 1 is mounted.

(3) The energy absorption mechanism 30 includes the wire 32 and the wire holder 33 that holds the wire 32. The locking pin 35 is inserted in the locking hole 33d formed on the wire holder 33.

The switching mechanism 31 with such a configuration makes the EA load changed in accordance with the presence or absence of an actuation signal from the sensors, improving collision safety performance of a vehicle on which the steering column device 1 is mounted.

### OTHER EMBODIMENTS

A steering column device 1A according to another embodiment is described below.

The steering column device 1A shown in FIG. 9 is provided with two energy absorption mechanisms 30 (two pairs of the wire 32 and the wire holder 33). The wire holder 33 of one energy absorption mechanism 30 of the two energy absorption mechanisms 30 is locked by the locking pin 35, and the wire holder 33 of the other energy absorption mechanism 30 of the two energy absorption mechanisms 30 is fixed and held with respect to the drive member 13 using the locking screw 34.

Next, operation of the steering column device 1A in a secondary collision is described.

When it is determined to set the high load setting due to a relatively large impact load given to the steering wheel from a driver in a secondary collision, and the like, the pyro actuator 23 remains off as shown in FIG. 10. When the pyro actuator 23 remains off, the wire holder 33 of the one energy absorption mechanism 30 of the two energy absorption mechanisms 30 is held by the locking pin 35 with respect to the drive member 13.

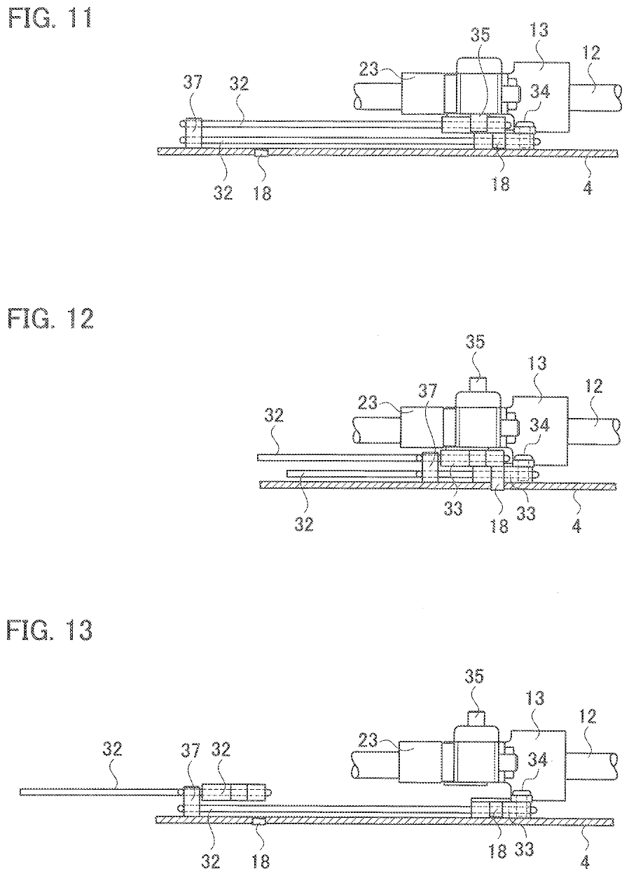

When an upper part of the steering shaft 7 and the upper jacket 4 move forward along the axial direction due to the impact load given to the steering wheel, the shear pin 18 receives a shearing force by the movement to be cut, so that the upper jacket 4 is detached from the drive member 13. The detached upper jacket 4 moves forward together with the upper part of the steering shaft 7. Then, as shown in FIG. 11, the wire 32 of the one energy absorption mechanism 30 is pulled forward by the locking protrusion part 37 to be plastically deformed, and thus the energy in the secondary collision is absorbed by the plastic deformation. Moreover, when the upper jacket 4 moves forward along the axial direction, the energy in the secondary collision is absorbed also by the other energy absorption mechanism 30 of the two energy absorption mechanisms 30. As described above, the two energy absorption mechanisms 30 effectively absorb a relatively large amount of energy.

On the other hand, when it is determined to set the low load setting due to a relatively small impact load given to the steering wheel from a driver in a secondary collision, and the like, the pyro actuator 23 is turned on as shown in FIG. 12. Then, the locking pin 35 is pulled off from the locking hole 33d of the wire holder 33 of the one energy absorption mechanism 30 of the two energy absorption mechanisms 30, and the wire holder 33 of the energy absorption mechanism 30 with respect to the drive member 13 is released.

The upper part of the steering shaft 7 and the upper jacket 4 move forward due to the impact load given to the steering wheel. Then, the wire 32 of the one energy absorption mechanism 30 is pulled forward by the locking protrusion part 37, and the wire holder 33 also moves forward together with the wire 32. As shown in FIG. 13, since the wire holder 33 also moves forward together with the wire 32, the one energy absorption mechanism 30 does not contribute to the energy absorption in a secondary collision. When the upper jacket 4 moves forward, the energy in the secondary collision is absorbed by the other energy absorption mechanism 30 of the two energy absorption mechanisms 30.

In summary, in the case of the low load setting, energy in the secondary collision is absorbed by only one energy absorption mechanism 30 of two energy absorption mechanisms 30, so that a relatively small amount of energy is effectively absorbed. On the other hand, in the case of the high load setting, energy in the secondary collision is absorbed by two energy absorption mechanisms 30, so that a relatively large amount of energy is effectively absorbed.

The steering column device of the present invention is described according to the above-described embodiments. However, it is not limited to the embodiments, and various other embodiments are adoptable without departing from the scope of the present invention.

What is claimed is:

1. A steering column device, comprising:
a lower jacket to be mounted on a vehicle body;
an upper jacket provided to be movable in front and rear directions of the vehicle body with respect to the lower jacket;
an electric actuator provided on the lower jacket for moving the upper jacket in the front and rear directions of the vehicle body;
a drive member transmitting a drive force of the electric actuator to the upper jacket;
an energy absorption mechanism arranged between the upper jacket and the drive member; and
a switching mechanism arranged between the drive member and the energy absorption mechanism, the switching mechanism switching between a state in which the energy absorption mechanism is locked with respect to the drive member and a state in which locking of the energy absorption mechanism with respect to the drive member is released.

2. The steering column device according to claim 1, wherein
the switching mechanism comprises a locking pin that locks the energy absorption mechanism, and a pyro actuator that actuates the locking pin.

3. The steering column device according to claim 2, wherein
the energy absorption mechanism comprises a wire and a wire holder that holds the wire, and
the locking pin is inserted in a locking hole formed on the wire holder.
